(19) United States
(12) Patent Application Publication
(10) Pub. No.: US 2008/0026356 A1
(43) Pub. Date: Jan. 31, 2008

(54) Student selector and timing device and method

(76) Inventor: Miguel Luis Kagan, San Clemente, CA (US)

Correspondence Address: MIGUEL KAGAN, PO BOX 72008, SAN CLEMENTE, CA, 92673, US

(21) Appl. No.: 11/486,864

(22) Filed: Jul. 17, 2006

(51) Int. Cl. G09B 3/00

(52) U.S. Cl. 434/322

(57) ABSTRACT

An electronic student selector and timing device has a plastic casing 20, a liquid crystal student selector display 22 for displaying a selected student from a classroom or team pool, and a liquid crystal timer display 24 for displaying the time remaining for the selected student to respond or present. The device sounds an alarm via a sound emitter 34 when the time is up. The selection and timing operations are controlled by a processing chip 56 operatively connected to the user controls and displays. The student selector button 26, timer button 28, and adjustment buttons 32 are used for setting the pool from which the student is selected and setting the selected student's time allotment. The selection algorithm for selecting the outcome from the selection pool may be chosen by the instructor based on the intended use. The device is hand-held and portable, but with a large enough or bright enough display to be visible to the entire classroom.

### BACKGROUND

1. Field of Invention

This invention relates to selection devices and timers, specifically to a student selector and response timing device for teaching.

2. Description of Prior Art

This device aims to facilitate the implementation of two established educational principles to accelerate learning, and make classroom participation more equitable. The first principle, individual accountability, is the process of holding individuals publicly accountable to the teacher (or to classmates in team-based activities) for a public display. Instructors regularly hold students individually accountable as when a teacher calls on an individual student. When students know they will have to publicly perform or exhibit their knowledge, they are more attentive, more involved, and their achievement increases.

The second instructional principle, equal participation, is ensuring approximately equal participation opportunities for all students. Research suggests classroom participation is lamentably unequal, with some students participating frequently and for great durations and others not at all. This participation pattern greatly contributes, perhaps predictably, to unequal achievement levels.

To bolster accountability and remedy the problem of unequal participation, students or student teams can be held accountable for participating in front of the classroom or in front of teammates for approximately the same frequency and duration. To do so, an instructor would need to select students with approximately equal frequency and provide approximately equal time allotments for the student or teams to share. No single teaching device currently exists for selecting students with equal frequency and providing equal time allotments for public sharing. The invention claimed herein shares similarities with prior-art random selection devices and timekeeping devices, but combines them with improvements to create a novel device that creates a synergistic result effect with unobvious results. We turn to prior-art.

Existing random selection devices such as spinners, dice, lottery wheels, and computer software enable an instructor to randomly select a single student from the class. Clocks, stopwatches, countdown timers, and other timekeeping mechanisms are ubiquitous and enable instructors to allot a predetermined time interval for a student response. However, current state of the art in instructional selection devices suffers from a number of disadvantages for the desired utility:

a) Management of Separate Devices. Random selection devices exist as independent entities; so do timekeeping devices. No devices presently exist that combine specific selection processes and timing means that make it easy to select a student, then provide that student a predetermined time allotment for sharing. Separate devices not designed for the intended use can be cumbersome to manage and operate in unison. Even with independent use of existing art, they lack numerous advancements disclosed herein.

b) Increased Manufacturing Costs. Separate devices have an increased manufacturing cost compared to an integrated device. Separate devices require separate molds, separate processing chips, separate display areas, separate production runs—all of which increase cost and therefore price to teachers.

c) Lack of Simultaneous Initiation. As separate devices, an instructor cannot easily simultaneously initiate both a student selection and timing sequence.

d) Inflexible Selection Algorithms. Spinners are presently the most commonly used student selection devices. Random spinners (see Kagan Publishing catalog, 2005) allow a user to randomly select a student. However, each outcome has an equal probability of being selected again with each new spin. This poses a major disadvantage in instructional settings. For the purpose of student selection or team selection, a non-repeating random selection algorithm is preferable to completely random selection for each spin as when the instructor wishes to randomly select each team or student to respond, but does not want any single team or student to be selected again before all others have responded. With in-use random selection devices, the same outcome may be selected multiple times before a different outcome is selected. With many possible outcomes, multiple spins may be required to select a unique outcome, wasting valuable instructional time.

Random selection methods such as names in a hat, lottery wheels, and cards may be employed to ensure non-repeating outcomes by removing the possible outcome from the selection pool. However, as described below, these methods have other distinct disadvantages.

Other selection algorithms are desirable in the classroom setting, including a sequential algorithm for the instructor to select the next student or team to present in a predefined sequence. Existing classroom selection devices do not empower the user to choose the desired selection algorithm for the teaching objective.

e) Predetermined Selection Pool. Random selection spinners usually operate by spinning a selection instrument such as an arrow, dial, or needle around an axis. When the selection instrument comes to rest, it points to or rests within the boundaries of one of the possible outcomes. Random selection wheels function similarly, but differ in that the selection alternatives rotate while the selection instrument is stationary. In either event, the possible outcomes are predetermined. This poses a problem for instructional group sizes that may vary on a daily basis as when there are absences, or even more frequently as when the teacher works with a subset of students. Multi-sided dice suffer a similar flaw. A different selection spinner, die, or wheel is required for each different possible outcome pool which is impractical given the variety of possible uses and possible pool sizes.

A clever designs that overcomes this problem (Kagan Publishing catalog, 2005) is a spinner with concentric circle, each circle with different pool sizes. With this design, the same spin can simultaneously select outcomes for differing pool sizes. However, this presents a cluttered and potentially confusing display and limits the display size of each outcome in proportion to the number of selection pools displayed.

f) Limitations of Multiple Selectors. Multiple selectors are desirable when, for example, the teacher wishes to at some times select a student, at some times select a team, and at some times select a specific student within a team. Dual spinners that have a team selector spinner and a student selector have been designed for this exact purpose (Kagan Publishing catalog, 2005) but they suffer many of the other disadvantages stated above.

g) Lack of Portability. Computer software exists for various forms of random selection and software exists for various timekeeping functions. Stationary computers and even portable laptop computers are not designed for the instructor to hold in hand or in pocket to move freely about the classroom. Similarly, they are not easily transported to another instructional setting such as another classroom, lecture hall, or sports field. A portable device such as a PDA obviates the need to return to a stationary location to perform an operation and can be easily programmed with multiple selection algorithms, simultaneous initiation of a student selector and timer, but no software for the desired utility currently exists. Further PDAs and small, portable devices suffer the following disadvantage.

h) Limited Display. Small mechanical devices such as spinners, dice, and digital devices such as stopwatches and PDAs have the advantage of being portable, but do not display their processes or results so that they are viewable to a large group. Only the instructor or nearby individuals have access to the selection and timing process and the selection results. The drawback of the selector not being viewable is that the selection process lacks the desired fun and suspense. Teaching devices have been proposed specifically for increasing the spinning nature of the spinners and drama of the selection (U.S. Pat. No. 6,120,022 to Stokes, 1998). The problem with the timer not being viewable is students cannot manage their own response or presentation times.

Overhead projectors are common in many classrooms. Devices have been invented that use the overhead projector to enlarge the display so that the image is viewable to a large group. A projectable timer (U.S. Pat. No. 5,590,944 to Stokes, 1997) has a transparent LCD display for use on the overhead projector. Transparent spinners (Kagan Publishing catalog, 2005) and overhead dice (EAI Education catalog, 2005) exist for the overhead projector. All necessitate an overhead projector, not available, convenient, nor desirable in many settings. Additionally, overhead projectors are being replaced by digital projectors.

Talking timers (Science Kit catalog, 2005) announce time remaining, but the audio signal interferes with classroom responses and presentations. Visual timers with warning lights (Learning Resources catalog, 2005), large display timers, and bright timers all solve the display problem for timers, but heretofore have not been combined with a student selection device, much less a sophisticated electronic selector device as disclosed herein.

### OBJECTS AND ADVANTAGES

Accordingly, several objects and advantages of the present invention are to provide a combined student selector and timing device and method that:

a) does not require use and management of separate devices;

b) reduces manufacturing costs through shared components;

c) enables the user to simultaneously initiate a selection and timing sequence;

d) allows users to choose the appropriate selection algorithm for the teaching objective;

e) enables a user to define and easily modify the selection pool;

f) allows the user to select from multiple selection pools;

g) is portable and may be easily transported within and outside the classroom;

h) indicates the selection and timing processes to large groups enhancing the suspense of selection and time management by the selected student;

Further objects and advantages are to provide a selector and timing device that is easy to use, promotes individual accountability to keep students actively involved in learning, equalizes classroom participation patterns, and ultimately adds flexibility for instructors and advances the field of instruction. Still further objects and advantages will become apparent from a consideration of the ensuing description and drawings.

### DRAWING FIGURES

FIG. 1A is a frontal view showing a preferred embodiment of an electronic student selector and timing device.

FIG. 1B is a side view of a preferred embodiment of an electronic student selector and timing device.

FIG. 1C is a back view of a preferred embodiment of an electronic student selector and timing device.

FIG. 1D is an internal view of a preferred embodiment of an electronic student selector and timing device.

FIG. 2 is a frontal view of an alternate embodiment of an electronic student selector and timing device.

FIG. 3 is a frontal view of a preferred embodiment of an electronic student selector and team selector device.

FIG. 4 is a frontal view of an alternate embodiment of an electronic student selector and timing device, using visual means for indicating time progression and selection.

### REFERENCE NUMERALS IN DRAWINGS

20 Casing
22 Student selector display
24 Timer display
26 Student selector button
28 Timer button
30 Start/stop button
32 Adjustment buttons
34 Speaker
36 Stand
38 Volume adjustment dial
40 Power switch
42 AC/DC adaptor input
44 Shared display
46 Team selector display
48 Team selector button
50 Battery
52 Screws
54 Algorithm selector switch
56 Processor chip
58 Battery door
60 Connection wires

### SUMMARY

In accordance with the present invention, a student selector and timing device comprises a plastic casing with a cavity for a power supply, a processor chip, and a sound emmitter operatively connected to buttons for setting and initiating the selection and to a display unit for displaying the selected outcome and the clocking of time progression allotted to said selected outcome.

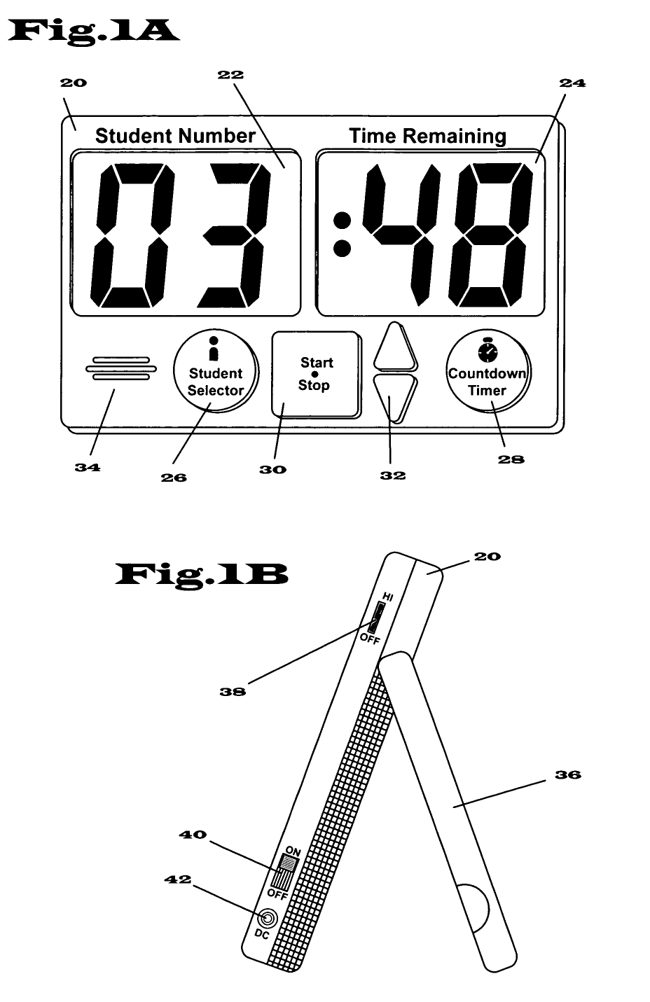

### Description—FIGS. 1 to 4

A typical embodiment of the selection and timing device of the present invention is illustrated in FIG. 1A, FIG. 1B, FIG. 1C, and FIG. 1D. FIG. 1A (frontal view) shows the plastic casing 20 that provides the basic structure to the device. The casing 20 is made of molded front and back parts that when coupled create an internal cavity. The typical case 20 size is approximately 7 inches in height, 10 inches in width, and 1 inch in thickness. This size accommodates a large LCD student selector display 22 and a large timer display 24, viewable to an audience at a distance, while remaining small enough to be portable.

The device includes buttons for operation including the student selector button 26, the countdown timer button 28, a start/stop button 30, and adjustment buttons 32. Molded into the casing 20 are slots for the speaker 34 housed within the casing 20.

FIG. 1B (side view) shows a stand 36 for optionally standing the device on a desk or table top. There is a volume dial 38 to adjust the volume of the speaker 34. Also on the side of the device is a power switch 40 and an AC/DC Adaptor input 42.

FIG. 1C (back view) shows a battery door 58 in the case 20. The front and back of the casing 20 are held together by a plurality of screws 52. The stand 36 retracts into the body 20 when not in use. There is an algorithm selector switch 54 to select between three selection algorithms.

FIG. 1D (interior view) shows the interior cavity of the device with the back portion of the casing 20 removed. The processor chip 56 is operatively connected via connection wires 60 to LCD displays 22 and 24, the operation buttons 26, 28, 30, 32, speaker 34, volume dial 38, power switch 40, AC/DC input 42, and the battery 50.

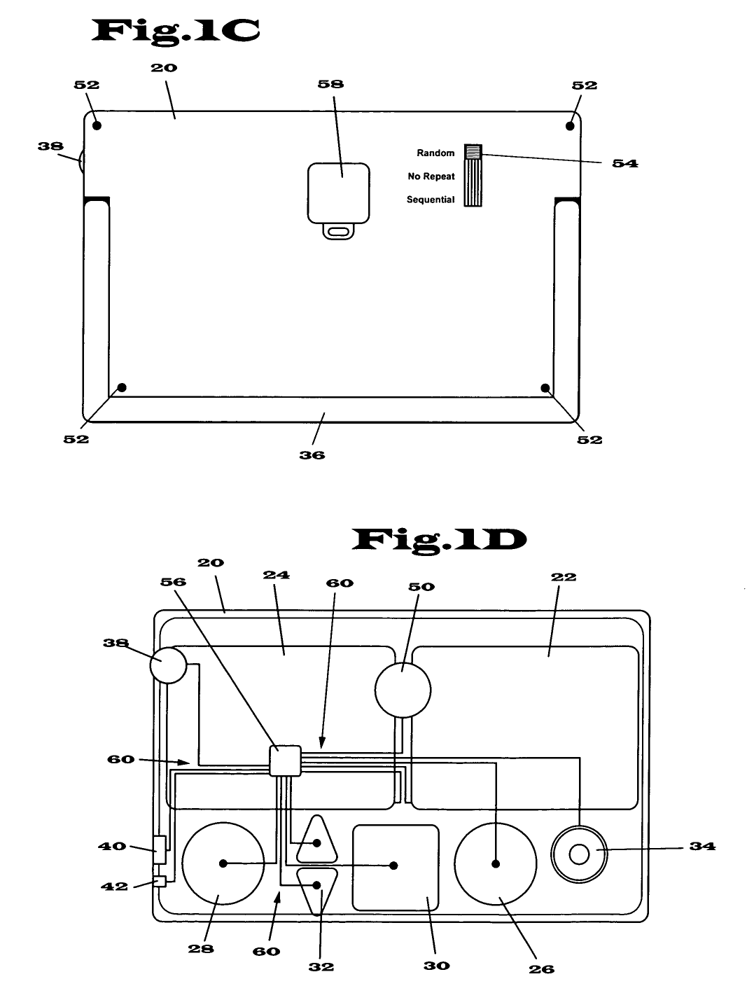

A few of the myriad alternative embodiments are shown in FIGS. 2, 3, 4. The embodiment illustrated in FIG. 2 shows an oval casing 20. The casing 20 can take a variety of shapes, sizes, and designs. The display 44 in this embodiment combines the student selector display, team selector display, and timer display as a single LCD display. A variety of indicating means may replace the display including: a projectable LCD display, LCD display with backlight, and LED display, laser projection, light emission, sound emission, video signal output, audio signal output. LED displays and backlights increase the visibility of the display but increase the cost and power requirements.

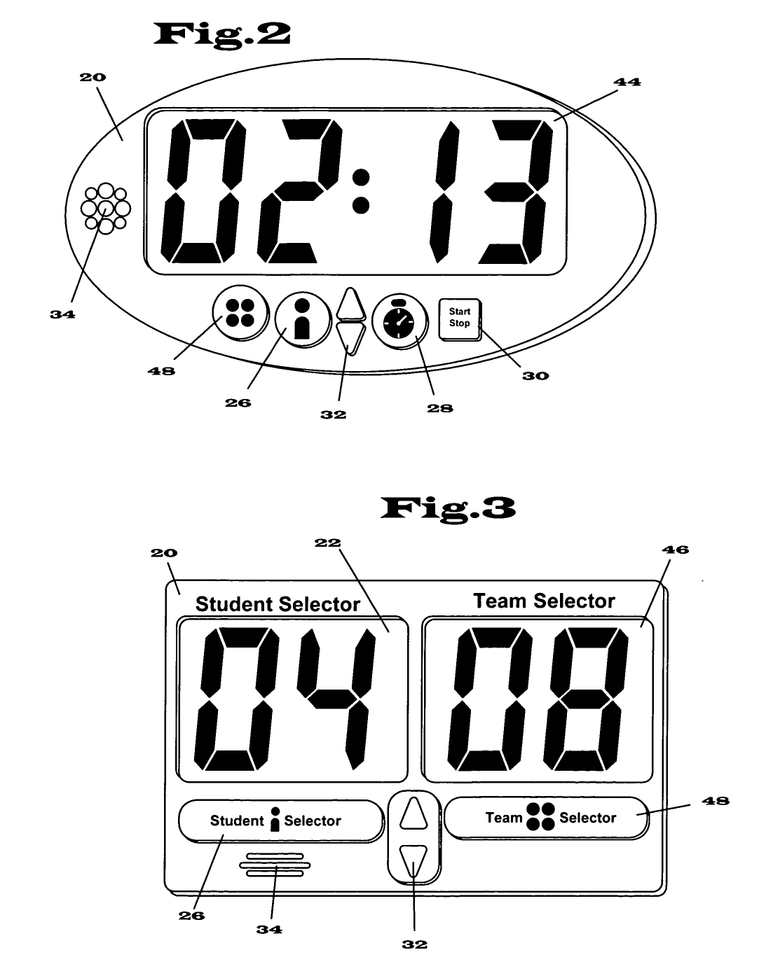

FIG. 3 shows the device with two selectors, a student selector display 22, and a team selector display 46. This embodiment eliminates the timing component. In this embodiment, there is a team selector button 48 in addition to the typical student selector button 26.

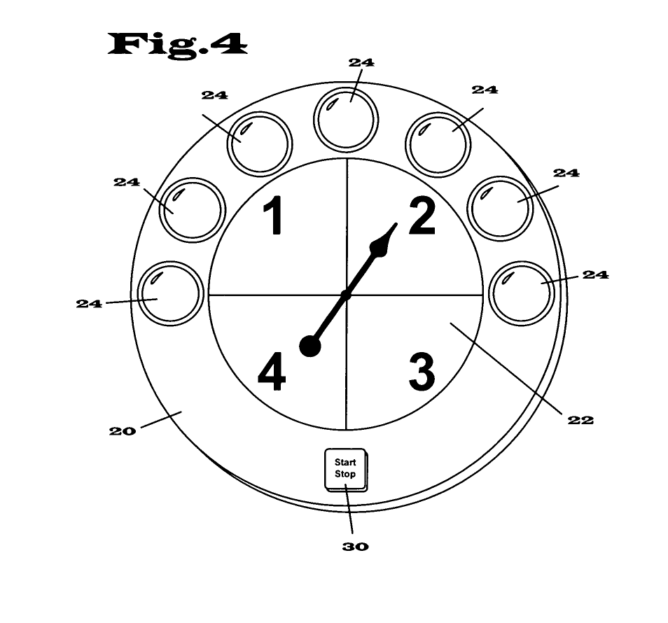

FIG. 4 shows an embodiment with a graphical depiction of both the timer display 24 and the student selector display 26. The timer display 24 is shown as LED lights that turn off as time elapses. The student selector 22 is shown as an LCD spinner animation. The display of both the timer and student selector can be graphically represented in a multiplicity of fashions. For example, time may be represented with a progress bar, pie chart, stoplights, bars on a graph. The selected student may be represented with a spinner, dice, wheel, symbol, color, number, picture, letter, or any number of possible representations.

The basic devise may take a variety of additional embodiments. The device may be completely mechanical as in an analog clock for the timing, and a spinner for selecting. The devise may also be programmed as software with the same basic functionality.

### Operation—FIGS. 1A to 1C and 2 to 3

To use the typical device illustrated in FIG. 1A, the instructor sets the selection pool and the desired time for the selected student to share or respond. To enter the selection pool, the instructor presses the student selector button 26 and uses the adjustment buttons 32 to enter the pool. If the instructor wishes to select one student in a class of thirty, the pool number is thirty. If students are seated in teams, the pool is the maximum number of students in each team. The instructor may also use the algorithm selection switch 54 (FIG. 1C) to select an algorithm: a) random b) non-repeating random, or c) sequential. To set the timer, the instructor presses the timer button 28 and uses the adjustment buttons 32 to program the desired time. The instructor may also select the pool and/or time from preset options.

To initiate the selection and begin the timing, the instructor presses the start/stop button 30. The student selector display 22 performs an animation, randomly cycling through numbers to create suspense whose number will be called. Once a student number is selected, the timer is triggered and time counts down on the timer display 24. When time is up, an alarm sounds through the speaker 34.

To initiate a new selection and timing once the time is up, the operator presses the start/stop button 30 again. The start/stop button 30 may also be used to pause and resume the timing. When the timer is running, no new student is selected. If the instructor wishes to adjust either the student pool or allotted time, the instructor repeats the procedures for setting the device.

On the side of the device, FIG. 1B, the instructor may adjust the alarm volume using the volume adjustment dial 38. The instructor may conserve batteries by turning off the main display using the power switch 40, while retaining settings in memory. The instructor may plug the device into a power supply by plugging an AC/DC adapter into the AC/DC adapter input 42.

FIG. 2 shows the display 44 as a unitary display. In this embodiment, the user may switch between the student selector, team selector, and timer function, similar to the modes on a digital wristwatch. Alternatively, the large display can be partitioned into three separate areas to simultaneously display three functions. Additional modes may be incorporated into the device such as: time, date, temperature, random number generator, stopwatch, making the device a multifunctional teaching device.

FIG. 3 shows an embodiment combining a team selector with a student selector without a timer. For this embodiment, the user presses either the student selector button 26 to use the student selector, the team selector button 48 to use the team selector, and both buttons (26 and 48) to initiate both selectors. Alternatively, a button may be included that initiates both the student and team selectors. To set the student pool, the user holds down the student selector button 26 until the student selector display 22 blinks, then uses the adjustment buttons 32 to adjust the pool. To set the team pool, the user holds down the team selector button 48 until the team selector display 46 blinks, then uses the adjustment buttons 32 to adjust the pool. This device is particularly useful for instructors using teams. The instructor may select any student in the class by first selecting a team, then selecting any student within the team.

From the description of the structure and operation of the present device, a number of advantages become evident. The student selector and timer device:

a) does not require use and management of separate timers and selection devices;

b) reduces manufacturing costs by integrating the selector and timer into a unitary device;

c) enables the user to simultaneously initiate a selection and timing sequence;

d) allows users to choose the desired selection algorithm for the teaching objective;

e) enables a user to define and easily modify the selection pool;

f) allows the user to select from multiple selection pools;

g) is portable and may be easily transported within and outside the classroom;

h) indicates the selection and timing processes to large groups enhancing the suspense of selection and time management by the selected student;

Clearly, combining a student selector and timer as a unitary device, and designing their structure and function as disclosed herein results in a novel, synergistic effect, not obvious, nor presently available with the state of the art.

### Conclusion, Ramifications, and Scope

Although the description above contains many specificities, these should not be construed as limiting the scope of the invention but as merely providing illustrations of some of the presently preferred embodiments of this invention. For example, the selector and timer device may be used for meetings, games, or for other applications; the case may take a different shape, size, or design; the device may be designed as software and projected via a digital projector; student pictures or names may be displayed instead of representational numbers or symbols; multiple selectors may be included with different algorithms and pool sizes; many additional features may be added to alter and augment the basic embodiment; the device may be a large device positioned for easy viewing in a class and operated remotely; the device may announce the selection outcomes or time progression with prerecorded audio messages. Thus the scope of the invention should be determined by the appended claims and their legal equivalents, rather than by the examples given.

What is claimed and desired to be secured by Letters Patent of the United States is:

1. An electronic selection and timing device comprising:
a) selection means for selecting an outcome from a pool of alternatives;
b) timing means for clocking time progression;
c) indicating means operatively connected to said selection means for indicating said selected outcome;
d) indicating means operatively connected to said timing means for indicating said time progression;
whereby an a outcome from a pool of alternatives may be selected and indicated and time may be clocked for said outcome.

2. The selection and timing device of claim 1 further including adjustment means for an operator to adjust the pool size and/or time interval.

3. The selection and timing device of claim 1 wherein said timing and selection means may be initiated independently or simultaneously.

4. The selection and timing device of claim 1 wherein said selection indicating means and said timing indicating means are selected from the group consisting of: LCD display, LED display, projectable LCD display, laser projection, light emission, sound emission, video signal output, audio signal output.

5. The selection and timing device of claim 1 wherein said timing indicating means is selected from the group consisting of: clock, stopwatch, countdown timer, graphical depiction of time, warning lights, sounds, time announcements, or alarms.

6. The selection and timing device of claim 1 wherein said selection means operates on a random, non-repeating random, or sequential algorithm.

7. The selection and timing device of claim 1 wherein said device is portable.

8. The selection and timing device of claim 1 wherein said device is operated remotely.

9. The selection and timing device of claim 1 further including an additional selector or selectors.

10. An electronic student and team selector device comprising:
a) selection set means for adjusting the students represented in a selection pool;
b) selection set means for adjusting the teams represented in a selection pool;
c) selection means for selecting a student from said set selection pool;
d) selection means for selecting a team from said set selection pool;
e) indicating means for indicating the selected student and/or team;
whereby a user may set the selection pools for students and teams, select a student and/or team, and display the selected student and/or team.

11. The electronic student and team selector device of claim 10 further including time clocking and display means.

12. The electronic student and team selector device of claim 10 wherein said student selector means and said team selector means may be initiated independently or simultaneously.

13. The electronic student and team selector device of claim 10 wherein said indicating means visually depicts the selection using representations of the selected outcome, including spinners, dice, wheels, dials, alphabetic display, pictures, names, symbols.

14. The electronic student and team selector device of claim 10 wherein said indicating means is selected from the group consisting of: LCD display, LED display, projectable LCD display, laser projection, light emission, sound emission, video signal output, audio signal output.

15. The electronic student and team selector device of claim 10 further including an additional selector or selectors.

16. A method of selecting an alternative from a pool and clocking time progression for the selected alternative comprising:
a) selection set means so an operator may set a pool from which an alternative will be selected;
b) timing set means so an operator can set a time interval;
c) selection means for selecting an outcome from the set pool;
e) initiating means for initiating the selection;
f) initiating means for initiating the timing;
g) display means for displaying the selected outcome;
h) display means for displaying time progression;
whereby an a outcome from an operator-defined pool of alternatives may be selected and displayed and time may be clocked for said outcome.

17. The selecting and timing method of claim 16 wherein said method is coded as software.

18. The selecting and timing method of claim 16 wherein said method is engineered as a processing chip.

19. The selecting and timing method of claim 16 wherein said method is integrated into a self-contained electronic device.

20. The selecting and timing method of claim 16 wherein said method is mechanical.
